(19) United States
(12) Patent Application Publication
(10) Pub. No.: US 2010/0052403 A1
(43) Pub. Date: Mar. 4, 2010

(54) WEB ADJUSTOR

(76) Inventor: Chad A. Sparling, Kokomo, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/542,211

(22) Filed: Aug. 17, 2009

Related U.S. Application Data
(60) Provisional application No. 61/092,627, filed on Aug. 28, 2008.

(51) Int. Cl. B60R 22/30; A47D 15/00; A44B 11/12; B60R 22/10

(52) U.S. Cl. 297/479

(57) ABSTRACT

The disclosure shows a web adjustor for engaging a vehicle restraint system web. It includes a frame including a base and a pair of upstanding members, and a cam pivotally mounted between said pair of upstanding members. One or more ridges are provide on said cam for locking the web. A first release handle on said cam is disclosed, wherein pushing said first release handle releases the cam from the web. An extension is disclosed extending outwardly from said cam in a direction opposite of said first release handle. A generally smooth, or rounded, or non-abrading or cylindrically shaped surface is disclosed on an end of said extension, wherein pulling the web in a direction such that the web is caused to contact it thereby releasing tension on the web. The end thereof is disclosed as extending wider than the web and wider than the extension.

### CROSS-REFERENCE TO RELATED APPLICATIONS

This application claims the benefit of U.S. Provisional Application No. 61/092,627 filed Aug. 28, 2008, which is hereby incorporated by reference.

### FIELD OF INVENTION

The present invention relates to web locks used in a variety of applications including vehicle restraint systems.

### BACKGROUND

In the commonly owned U.S. Pat. No. 4,660,889 there is disclosed a harness web adjustor with child restraint seat. A handled cam is pivotally mounted between two flanges and is engagable with a web. Movement of the cam causes the web to be locked or unlocked relative to the web adjustor. Disclosed herein is an alternate form of a web lock or adjustor.

### SUMMARY

The claims, and only the claims, define the invention. The present invention includes several, but not necessarily all, a web adjuster for a vehicle restraint system web, comprising frame including a base and a cam pivotally mounted to said base. The web typically extends between said base and said cam, with one or more ridges on said cam for locking the web. An extension extending outwardly from said cam is provided. Pulling the web in a direction such that the web is caused to contact said extension and thereby rotates said cam thereby releasing tension on the web.

Other optional features that may be included, but are not required, are set forth in the various dependent and independent claims.

### BRIEF DESCRIPTION OF THE DRAWINGS

FIG. 1 is a perspective view of a web adjustor including my new invention.

FIG. 2 is a cross-sectional view taken on line 2-2 of FIG. 1 and viewed in the direction of the arrows.

FIG. 3 is a front view of a web adjustor including my new invention mounted on a child seat.

### BRIEF DESCRIPTION OF THE PREFERRED EMBODIMENTS

For the purposes of promoting an understanding of the principles of the invention, reference will now be made to the examples, sometimes referred to as embodiments, illustrated and/or described herein. Those are mere examples. It will nevertheless be understood that no limitation of the scope of the invention is thereby intended. Such alterations and further modifications in the described processes, systems or devices, any further applications of the principles of the invention as described herein, are contemplated as would normally occur to one skilled in the art to which the invention relates, now and/or in the future in light of this document.

As used in the claims and the specification, all terms have their ordinary meaning as found in common usage dictionaries.

Articles and phases such as, “the”, “a”, “an”, “at least one”, and “a first”, are not limited to mean only one, but rather are inclusive and open ended to also include, optionally, multiple such elements. Likewise, “comprising” is open ended and inclusive.

Referring to the drawing figures, these are only examples of the invention, and the invention is not limited to what is shown in the drawings.

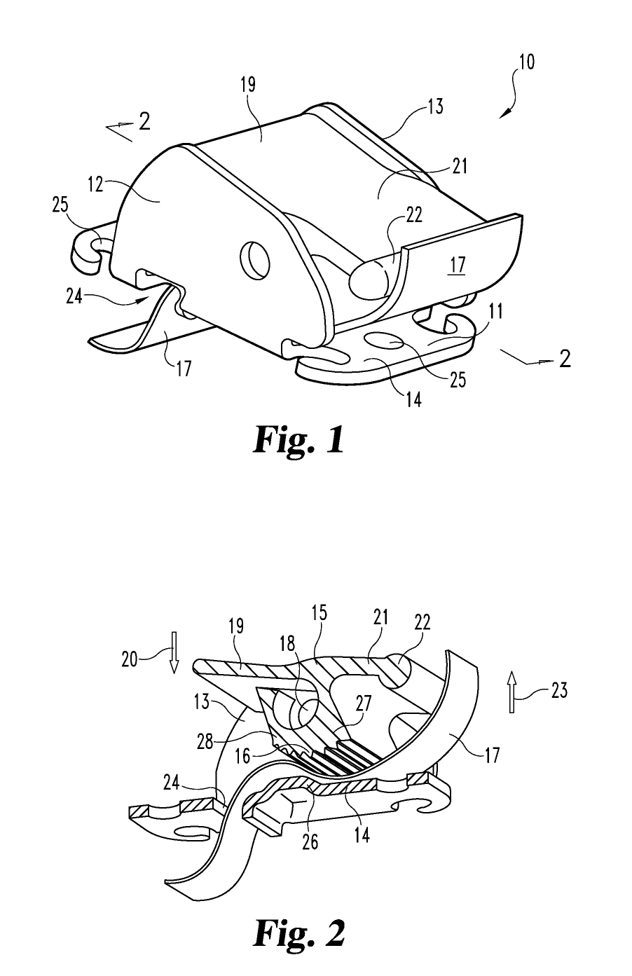

Referring now particularly to FIG. 1, there is shown a preferred embodiment of the present invention. Web adjustor 10 includes a main frame 11 having a pair of upstanding flanges 12 and 13 integrally joined to a base 14.

A handled cam 15 is pivotally mounted between flanges 12 and 13. Cam 15 has a main body with a plurality of downwardly facing ridges 16 that are engagable with web 17 extending between the ridges and base 14. A pin (not shown) extends through hole 18 of cam 15 and into flanges 12 and 13, thereby pivotally mounting the cam to flanges 12 and 13. An extension 19 extends outwardly from cam 15 forming a handle enabling the handle to be pushed downwardly in the direction of arrow 20 to release the cam from the web which occurs since ridges 16 are caused to move away from base 14. Release of handle 19 causes the helical spring (not shown) that extends around the pin and extending through hole 18 to rotate the cam in a clockwise direction as viewed in FIG. 2 and return the handle to the upward position thereby locking ridges 16 against web 17. Since the distance between ridges 16 and 14 decreased.

A second extension 21 extends outwardly from cam 15 in a direction opposite of handle 19 and has a cylindrical end 22 formed thereon. By pulling web 17, for purposes of adjustment, in the direction of arrow 23, the web is caused to contact cylindrical end 22 thereby rotating cam 15 in a counter clockwise direction as viewed in FIG. 2 thereby releasing tension on the web.

Base 14 includes an upraised portion 26 positioning the base closer to the cam in the area of the upraised portion. Ridges 16 are positioned on the bottom facing surface of the cam with those ridges located in the area 27 closest to cylindrical end 22 being a greater distance from the rotational axis of the cam extending through hole 18 than those ridges located in area 28 closest to handled extension 19. Thus, as web 17 is pulled in the direction 23, the web contacts cylindrical end 22 rotating the cam in a counter-clockwise direction as viewed in FIG. 2 and moving the ridges in area 27 closest to the base 14 away from the base and releasing the web.

As illustrated, extension 21 and handle 19 are on opposite sides of pivot 18 such that downward force on one (handle 19) corresponds, in terms of overcoming bias of the spring(s), to upward force on the other (extension 21). Although the device need not be limited to a T-shaped cam, as shown in FIG. 2, the cam preferably is generally T-shaped with handle 19 and extension 22 generally forming the lateral top of the “T” above pivot 18 and with ridges 16 along the bottom leg of the “T”.

Cylindrical end 22 may include, for example cylinder means such as any generally smooth, or rounded, or non-abrading or cylindrically shaped (partial or wholly cylindrical or otherwise curved) surface, fixed or movable (such as a roller). While less preferred, such means also comprise another shape such as a rectangular (or rounded corner rectangular) end of extension 21, either enlarged or the same cross-sectional size of extension 21. Or, the end may be a cylinder as drawn. The extension 21 preferably is in a direction opposite of handle 19 as illustrated, but also optionally may be other than opposite handle 19 if the functionality of having pulling the web such that the web is caused to contact it thereby releasing tension on the web. For example, this may be achieved by variations of the effective angle of the extension (running from the cam to the end of extension 21) as well as its effective length, such as to project the end into the operator optional path of the web when this The end 22 thereof is disclosed as extending wider than the web and wider than the second extension.

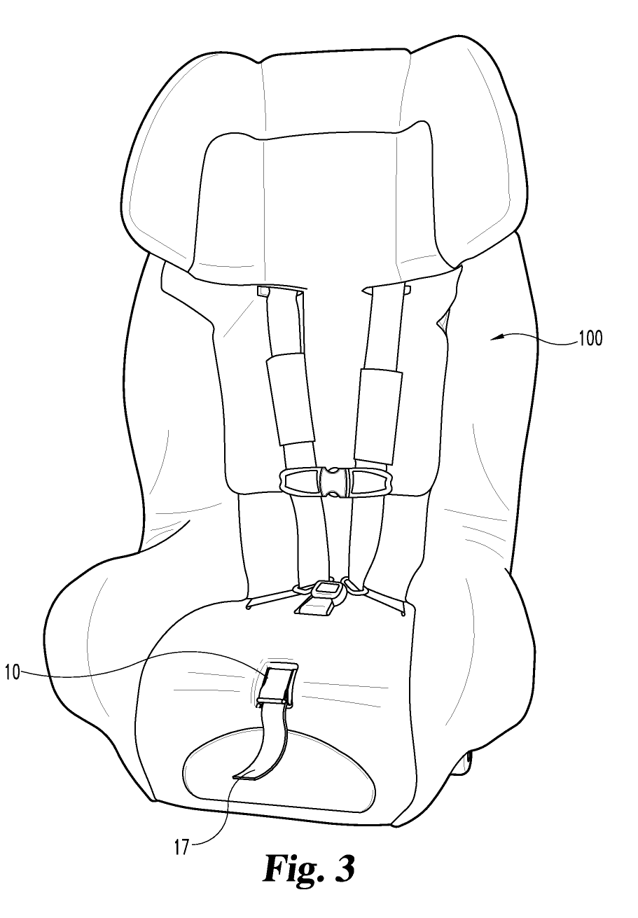

Base 14 includes a slot 24 through which web 17 extends to a splitter plate provided in the restraint system. A plurality of apertures 25 are provided in base plate 14 to allow the adjustor 10 to be fixedly mounted to a restraint system 100 (see FIG. 3), such as a child seat for mounting in a vehicle.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected. It is also contemplated that structures and features embodied in the present examples can be altered, rearranged, substituted, deleted, duplicated, combined, or added to each other.

What is claimed is:

1. A web adjustor for engaging a vehicle restraint system web, comprising:
A frame including a base and a pair of upstanding members;
A cam pivotally mounted between said pair of upstanding members;
Wherein the web extends between said base and said cam;
One or more ridges on said cam for locking the web;
Spring means for rotating said cam for locking the web;
A first release handle on said cam, wherein pushing said first release handle releases the cam from the web with said ridge being caused to move away from base;
An extension extending outwardly from said cam in a direction opposite of said first release handle;
Cylinder means on an end of said extension, wherein pulling the web in a direction such that the web is caused to contact said cylinder means thereby rotates said cam thereby releasing tension on the web.

2. The web adjuster of claim 1, and further comprising an upraised portion positioning the base closer to the cam in the area of the upraised portion.

3. The web adjuster of claim 2, and where said base includes a slot through which the web is extendable.

4. The web adjuster of claim 3, and comprising a plurality of ridges, wherein a ridge positioned on a bottom facing surface of said cam located in a first ridge area close to cylinder means is a greater distance from a rotational axis of the cam than a ridge located in a second ridge area close to said first release handle, wherein as the web is pulled in a direction such that it contacts said cylinder means and rotates the cam in a direction moving the ridges in said first ridge area away from said base and releasing the web.

5. The web adjuster of claim 4, and wherein said base and said pair of upstanding members are unitary, and further including a plurality of apertures in said base to allow the adjustor to be fixedly mounted to a restraint system, such as a child seat for mounting in a vehicle.

6. The web adjuster of claim 5, in combination with and mounted to a restraint system, such as a child seat for mounting in a vehicle.

7. The web adjuster of claim 6, and further comprising a splitter plate provided in a restraint system to which the web extends.

8. The web adjuster of claim 1, and where said base includes a slot through which the web is extendable.

9. The web adjuster of claim 1, and comprising a plurality of ridges, wherein a ridge positioned on a bottom facing surface of said cam located in a first ridge area close to cylinder means is a greater distance from a rotational axis of the cam than a ridge located in a second ridge area close to said first release handle, wherein as the web is pulled in a direction such that it contacts said cylinder means and rotates the cam in a direction moving the ridges in said first ridge area away from said base and releasing the web.

10. The web adjuster of claim 1, and wherein said base and said pair of upstanding members are unitary, and further including a plurality of apertures in said base to allow the adjustor to be fixedly mounted to a restraint system, such as a child seat for mounting in a vehicle.

11. The web adjuster of claim 1, in combination with and mounted to a restraint system, such as a child seat for mounting in a vehicle.

12. The web adjuster of claim 11, and further comprising a splitter plate provided in a restraint system to which the web extends.

13. A web adjustor for engaging a vehicle restraint system web, comprising:
A frame including a base;
A cam pivotally mounted to said base;
Wherein the web extends between said base and said cam;
One or more ridges on said cam for locking the web;
A first release handle on said cam, wherein pushing said first release handle releases the cam from the web with said ridge being caused to move away from base;
An extension extending outwardly from said cam;
wherein pulling the web in a direction such that the web is caused to contact said extension and thereby rotates said cam thereby releasing tension on the web.

14. The web adjuster of claim 13, and comprising a plurality of ridges, wherein a ridge positioned on a bottom facing surface of said cam located in a first ridge area is a greater distance from the rotational axis of the cam than a ridge located in a second ridge area, wherein as the web is pulled in a direction such that it contacts said extension such that it rotates the cam in a direction moving the ridges in said first ridge area away from said base and releasing the web.

15. The web adjuster of claim 14, and further including a cylinder on an end of said extension for contacting the web and thereby rotates said cam.

16. The web adjuster of claim 16, and further comprising a restraint system, such as a child seat for mounting in a vehicle.

17. The web adjuster of claim 13, and further including a cylinder on an end of said extension for contacting the web and thereby rotates said cam.

18. The web adjuster of claim 13, wherein said first release handle on said cam is opposite said extension.

19. The web adjuster of claim 13, and further including a spring to rotate said cam.

20. The web adjuster of claim 18, and further including a spring to rotate said cam.
